(19) United States
(12) Patent Application Publication
(10) Pub. No.: US 2010/0166172 A1
(43) Pub. Date: Jul. 1, 2010

(54) SUBSCRIBER LINE INTERFACE CIRCUITRY WITH INTEGRATED SERIAL INTERFACES

(76) Inventors: Jeffrey A. Whaley, Dripping Springs, TX (US); Xun Yang, Austin, TX (US); Joel W. Page, Austin, TX (US)

Correspondence Address: DAVIS & ASSOCIATES, P.O. BOX 1093, DRIPPING SPRINGS, TX, 78620, US

(21) Appl. No.: 12/347,986

(22) Filed: Dec. 31, 2008

(51) Int. Cl. H04M 1/00

(52) U.S. Cl. 379/399.01

(57) ABSTRACT

Methods and apparatus for communicating include a first device coupled to a second device with a bi-directional data line and a clock line. Frames of data are serially communicated between the first and second devices on the data line. Each frame is synchronized with a clock signal carried by the clock line. Each frame has a portion allocated to data communicated from the first device to the second device and another portion allocated to data communicated from the second device to the first device.

### BACKGROUND

A subscriber line interface circuit (SLIC) typically provides a communications interface between an analog subscriber line and a central office exchange of a telecommunication network. The analog subscriber line connects to subscriber equipment at a location remote from the central office exchange. The analog subscriber line and subscriber equipment form a subscriber loop.

The SLIC detects and transforms low voltage analog signals received from the subscriber equipment into digital data for transmitting upstream to a digital network such as the Public Switched Telephone Network. The analog voiceband signals are converted to pulse code modulated (PCM) digital voiceband signals for communication upstream. The SLIC must also transform digital voiceband signals received from the digital network into low voltage analog voiceband signals for transmission downstream to the subscriber equipment. Commands and settings for the SLIC are communicated on a different bus such as a serial peripheral interface (SPI) bus. A SLIC may include both a PCM bus interface and an SPI bus interface.

The SLIC and subscriber line form part of the wireline infrastructure. Other technologies have leveraged the installed base of wireline infrastructure to provide data services to customers.

Optical communications networks are used to transport large amounts of information attributable to voice, data, and video communications. These communications are in the form of optical signals carried by fiber optic cables. Optical fiber infrastructure has begun to encroach on traditional wireline infrastructure as optical fiber is extended closer to customer premises.

For example, fiber has been extended from the central office “to the curb”, i.e., a service node near one or more customer buildings as a result of growing demand for increased bandwidth at a local level. The connection between individual buildings and the service node is completed with traditional wireline medium such as copper wires. An optical network unit (ONU) provided the optical-to-electrical and electrical-to-optical conversion required for interfacing the fiber portion of the network with the copper wire portion. The ONU communicates with an optical line terminal (OLT) at the central office.

Decreasing costs of fiber, increasing demand for bandwidth, and lower infrastructure costs have encouraged extension of the optical fiber all the way to the customer premises. An optical network terminal (ONT) terminates the fiber optic network at or near the customer premises and provides the interface between the optical network and any electrical media.

Due to the advent and expansion of optical network infrastructure, the location of the SLICs has moved out of the central office exchange closer to customer premises. For example, the optical-to-electrical conversions, ringing, etc. are performed in devices such as the ONU or ONT. The ONT or ONU includes a gateway component for coupling the SLIC to the central exchange via the optical network.

Although provision of both PCM and SPI bus interfaces offers flexibility in a SLIC, the corresponding interfaces are relatively costly for integrated circuit gateways due to the number of signal lines involved.

### SUMMARY

Methods and apparatus for communicating include a first device coupled to a second device with a bi-directional data line and a clock line. Frames of data are serially communicated between the first and second devices on the data line. Each frame is synchronized with a clock signal carried by the clock line. Each frame has a portion allocated to data communicated from the first device to the second device and another portion allocated to data communicated from the second device to the first device.

Methods and apparatus for communicating include coupling first and second devices with a first unidirectional data line, a second unidirectional data line, and a clock line. Frames of data are serially communicated between the first and second devices using the first and second unidirectional data lines. The frame formats of a frame carried by the first unidirectional data line is distinct from a frame format of a frame carried by the second unidirectional data line. Each frame is synchronized with a clock signal carried by the clock line.

Method and apparatus for communicating include communicating frames of data at a frequency f₁ serially from a first device to a second device using a first unidirectional data line. The frames have a first timeslot allocation of s timeslots. A clock signal having a frequency f₂ is generated within the second device, wherein

$$\frac{{f}_{2}}{{f}_{1}} \approx n \cdot s ,$$

wherein n>1. The first unidirectional data line is sampled every n clock cycles of the clock signal for a plurality of the timeslots.

Methods and apparatus for communicating include communicating frames of data having a first timeslot allocation of s timeslots serially from a first device to a second device using a first unidirectional data line at a frequency f₁. An edge of each frame as a detected edge. A clock signal having a frequency f₂ is generated in response to the detected edges, wherein

$$\frac{{f}_{2}}{{f}_{1}} \approx n \cdot s ,$$

wherein n>1, wherein the clock signal is maintained substantially synchronous to the detected edges. Frames of data having a second timeslot allocation of s timeslots are communicated serially from the second device to the first device using a second unidirectional data line at the frequency f₁ as derived from f₂.

Methods and apparatus for synchronizing communications between a first and a second device include serially communicating a frame having a first format from a first device to a second device, wherein only a frame synchronization timeslot (F1) is asserted. The serially communicated frame having the first format is sampled by the second device until the asserted F1 timeslot is detected. The second device serially communicates a frame having a second format to the first device, wherein only a frame synchronization timeslot (R1) is asserted. The serially communicated frame having the second format is sampled by the first device until the asserted R1 timeslot is detected. The first device establishes synchronization when these steps are successfully repeated. On the second sampling to detect the F1 timeslot, however, the sampling is windowed to less than one timeslot within the expected occurrence of the F1 timeslot.

In various embodiments the first and second devices include a SLIC and an optical network gateway.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a passive optical network architecture.

FIG. 2 illustrates one embodiment of an optical network terminal (ONT).

FIG. 3 illustrates one embodiment of a subscriber line interface circuit.

FIG. 4 illustrates one embodiment of an optical network element service block.

FIG. 5 illustrates another embodiment of an optical network element service block including a SLIC coupled to a gateway via a two-wire interface for transporting PCM and SPI communications.

FIG. 6 illustrates one embodiment of a frame format for information carried by the two-wire interface.

FIG. 7 illustrates one embodiment of a method of serially communicating between a first and a second device.

FIG. 8 illustrates one embodiment of a three-wire interface for coupling a SLIC and a gateway to transport PCM and SPI communications.

FIG. 9 illustrates one embodiment of frame formats for information carried by the three-wire interface.

FIG. 10 illustrates one embodiment of a method of serially communicating between a first and a second device.

FIG. 11 illustrates an alternative embodiment of a two-wire interface for coupling a SLIC and a gateway to transport PCM and SPI communications.

FIG. 12 illustrates one embodiment of frame formats for information carried by the two-wire interface of FIG. 11.

FIG. 13 illustrates one embodiment of a method of serially communicating between a first and a second device using the two-wire interface of FIG. 11.

FIG. 14 illustrates one embodiment of a frame synchronization protocol for the MSIF and TSIF.

FIG. 15 illustrates waveforms associated with detecting an edge of a frame for recovering/generating a clock signal.

FIG. 16 illustrates one embodiment of waveforms present when sampling frames.

### DETAILED DESCRIPTION

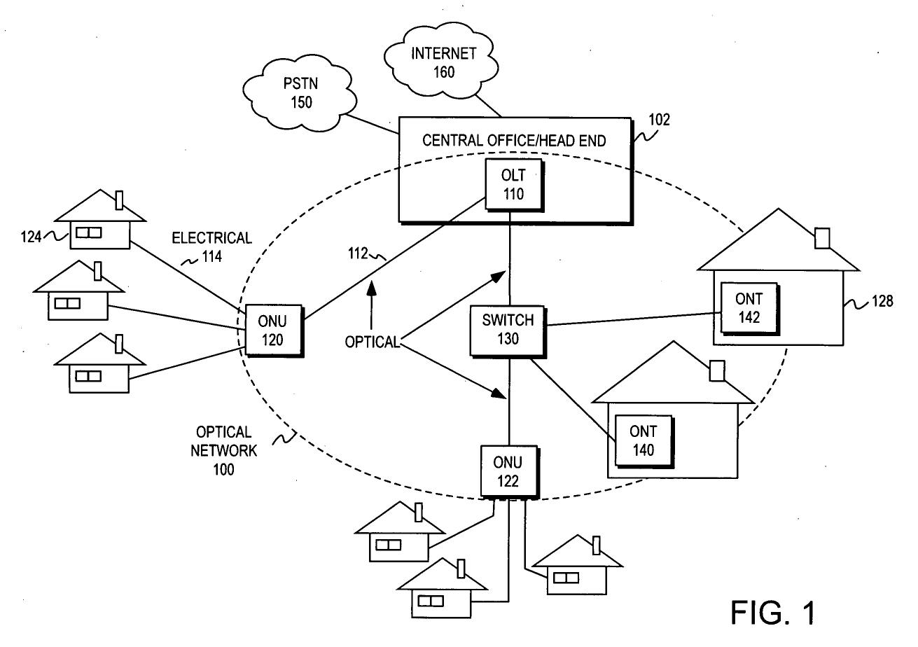

FIG. 1 illustrates one embodiment of a passive optical network 100. The optical network can include various network elements such as an optical line terminal (OLT 110), an optical switch 130, an optical network unit (ONU 120, 122), and optical network terminal (ONT 140, 142). The optical network may include various other elements such as amplifiers and repeaters that are not illustrated in this example.

The OLT is located at a telephone company central office or cable company head end 102. The OLT is the interface between the optical distribution network 100 and other networks such as a public telephone switching network (PSTN 150) or Internet 160.

Although each network element may perform electrical-to-optical conversions in order to achieve its intended function, the transmission media between the network elements within the optical network is optical. The OLT may be coupled to switches, ONUs, and ONTs via optical fibers such as optical fiber 112, for example.

Communications are typically distributed within the customer premises (such as businesses or homes 124, 128) electrically. Thus at some demarcation point, an electrical-to-optical conversion is required. ONUs and ONTs both provide such a conversion. Telephone wiring and coaxial cable are examples of types of electrical media 114 used. The information carried by the optical network typically corresponds to video, data, or voice communications.

The primary distinctions between ONUs and ONTs relate to the number of premises supported and the location of the network element. An ONU 120 is typically located near, but not necessarily at the customer premises. An ONU supports several different premises. In contrast, an ONT 140 extends the optical distribution network all the way to the customer premises and typically serves only one or perhaps a very small number of premises.

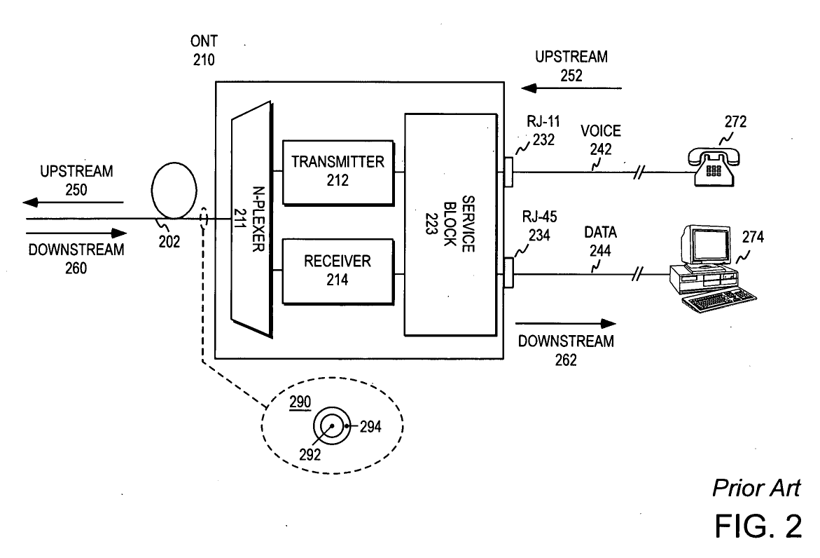

FIG. 2 illustrates one embodiment of a prior art optical network terminal (ONT 210). The illustrated configuration is a “fiber to the premises” optical network. In the illustrated embodiment, the ONT transports information attributable to voice and data communications.

Communications (upstream 250 and downstream 260) between the ONT and a central office headend are optical. The ONT terminates a first type of optical fiber 202 carrying upstream and downstream communications. In one embodiment, the first type of optical fiber 202 is a glass optical fiber (GOF). The glass optical fiber can be a single mode fiber or a multi-mode fiber.

Communications (upstream 252, downstream 262) between the ONT and customer subscriber equipment are electrical. The electrical signals may be carried by various electrical cabling including telephone wire (voice 242), coaxial cable, or other cabling (data 244). The ONT provides optical-to-electrical and electrical-to-optical conversion as well as other functionality required for interfacing the fiber portion of the network with the electrical portion of the network.

Service block 223 provides the electrical interface with the subscriber equipment such as telephone 272 and computer 274. In the illustrated embodiment, the telephone and computer are electrically coupled to the service block at RJ-11 connector 232 and RJ-45 connector 234 via the voice 242 and data 244 signal lines, respectively.

In addition to handling voiceband communications, the service block provides the appropriate POTS functions for subscriber equipment 272. For example, traditional subscriber line interface circuit (SLIC) functions must be provided at the ONT 210 given that the communication between the central office and the ONT are otherwise optical rather than electrical. In one embodiment, the service block 223 provides the BORSCHT functions (i.e., battery feed, overvoltage protection, ringing, supervision, codec, hybrid, and test).

As illustrated by callout 290, optical fiber 202 includes a core 292 and a cladding 294. The core and cladding have different refractive indices. An optical fiber 202 coupling the ONT to a distant upstream node such as a central office typically has a glass core and may be referred to as a glass optical fiber (GOF) based upon material of construction. In conjunction with wavelength division multiplexing, GOF can carry very large amounts of information between the customer premises and the central office.

In the illustrated embodiment, subscriber equipment such as telephones 272 and computers 274 are coupled to ONT 210 using different types of media. The type of media is dictated at least in part by electrical specifications associated with the related service.

For example, data 244 is often a multiconductor data cable such as an Ethernet cable for carrying digital signals. Plain old telephone system (POTS) equipment such as a telephone 272 typically uses copper wire pairs. Generally services provided to POTS equipment are referred to as voice 242. The term “voice” includes voiceband communications.

ONT 210 includes the appropriate physical connector to interface with the physical media for each service. For example, ONT 210 includes an RJ-11 connector 232 for voice services and an RJ-45 connector 234 for data services. ONT 210 provides the physical interface between the electrical and optical media. The customer premises may thus be wired with multiple media including POTS wiring and the appropriate data cabling to support the different services throughout the premises.

Upstream and downstream communications between the ONT and the central office share the same optical fiber media. Different services, however, may be associated with different wavelengths carried by the optical fiber. Channels and optical wavelengths may thus be provisioned based upon the content and direction of the communications among other factors. The optical signal carried by optical fiber 202 may be wavelength division multiplexed (WDM). In addition, the upstream and downstream channel may each be time-division-multiplexed to support the multiple services per channel.

An n-plexer 211 serves to aggregate optical signals generated by upstream transmitter 212 for upstream communications by optical fiber 202. The n-plexer also optically demultiplexes the incoming optical signal to extract selected downstream channels for the associated receiver 214.

The service block 223 provides the appropriate functionality for interfacing the ONT or ONU with the downstream subscriber equipment and the upstream optical network. For example, service block 223 may include a media access control (MAC) to permit unique identification of the ONT by the upstream optical network. Alternatively, in an ONU with multiple service blocks, each block might identify a MAC to permit unique identification of the customer premises connected to that block.

In one embodiment, data and voice share the same upstream and downstream channels on the optical fiber 202. Upstream voice and data, for example, may be time division multiplexed on a common upstream channel. Similarly, voice and data may be time division multiplexed on a common downstream channel. The service block de-multiplexes downstream voice and data communications. The service block multiplexes upstream voice and data communications from the subscriber equipment. Service block 223 also provides the appropriate electrical interface for the subscriber equipment. For example, service block 223 provides subscriber line interface circuit (SLIC) functionality to support subscriber equipment coupled to the voice connector 232.

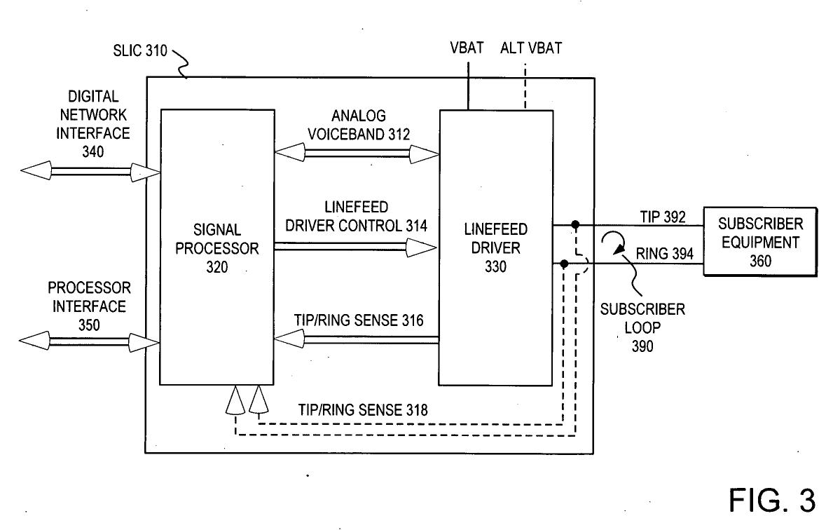

FIG. 3 illustrates one embodiment of a subscriber line interface circuit 310 associated with plain old telephone services (POTS) telephone lines. The subscriber line interface circuit (SLIC) provides a digital network interface 340 for communicating between a digital switching network of a local telephone company central exchange and the subscriber line comprising a tip 392 and a ring 394 line. A subscriber loop 390 is formed when the subscriber line is coupled to subscriber equipment 360 such as a telephone.

The subscriber loop 390 communicates analog data signals (e.g., voiceband communications) as well as subscriber loop “handshaking” or control signals. The subscriber loop state is often specified in terms of the tip 392 and ring 394 portions of the subscriber loop.

The SLIC is expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function enables the SLIC to signal the subscriber equipment 360. In one embodiment, subscriber equipment 360 is a telephone. Thus, the ringing function enables the SLIC to ring the telephone.

In the illustrated embodiment, the BORSCHT functions are distributed between a signal processor 320 and a linefeed driver 330. Signal processor 320 is responsible for at least the ringing control, supervision, codec, and hybrid functions. Signal processor 320 controls and interprets the large signal subscriber loop control signals as well as handling the small signal analog voiceband data and the digital voiceband data.

In one embodiment, signal processor 320 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 320 receives subscriber loop state information from linefeed driver 330 as indicated by tip/ring sense 316. The signal processor may alternatively directly sense the tip and ring as indicated by tip/ring sense 318. This information is used to generate linefeed driver control 314 signals for linefeed driver 330. Analog voiceband 312 data is bi-directionally communicated between linefeed driver 330 and signal processor 320. In an alternative embodiment, analog voiceband signals are communicated downstream to the subscriber equipment via the linefeed driver but upstream analog voiceband signals are extracted from the tip/ring sense 318.

SLIC 310 includes a digital network interface 340 for communicating digitized voiceband data to the digital switching network of the public switched telephone network (PSTN). The PSTN is designed to carry pulse code modulated (PCM) data. The SLIC codec provides bi-directional conversion of PCM data from the digital switching network to analog data for the subscriber loop. Thus in one embodiment digital network interface 340 is a bi-directional PCM interface.

The SLIC may also include a processor interface 350 to enable programmatic control of the signal processor 320. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold. The processor interface may also permit reading various alarms, current settings, subscriber line states, etc. from the signal processor. In one embodiment, the processor interface is a serial peripheral interface (SPI).

Linefeed driver 330 maintains responsibility for battery feed to tip 392 and ring 394. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (−48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vᵣₘₛ).

Linefeed driver 330 modifies the large signal tip and ring operating conditions in response to linefeed driver control 314 provided by signal processor 320. This arrangement enables the signal processor to perform processing as needed to handle the majority of the BORSCHT functions. For example, the supervisory functions of ring trip, ground key, and off-hook detection can be determined by signal processor 320 based on operating parameters provided by tip/ring sense 316.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

For central exchange applications, the signal processor and linefeed driver typically reside on a linecard to facilitate installation, maintenance, and repair. The signal processor and linefeed driver may be fabricated as integrated circuits. In one embodiment, the signal processor and linefeed driver may be packaged into the same integrated circuit package. Thus “SLIC 310” may represent a line card, an integrated circuit die, or an integrated circuit package depending upon design.

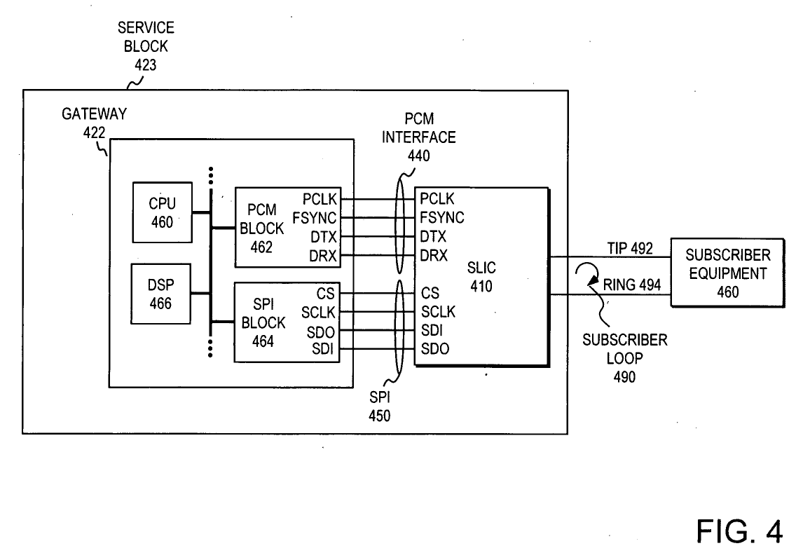

In an optical network environment, the SLIC is located within the service block of an ONU or an ONT rather than at a central office. FIG. 4 illustrates one embodiment of a service block 423 of an optical network element including a SLIC 410.

In the illustrated embodiment, a service block gateway 422 is coupled to the SLIC 410. The gateway 422 terminates the copper path from the subscriber much like the central office does in a traditional POTS network. However, the gateway is merely the gateway to the central office rather than the central office itself. The optical network element is coupled to the central office via the optical network. Gateway 422 provides additional functionality with respect to transporting communications between the optical network element and the central office.

The gateway must be capable of interfacing with the SLIC for bi-directional communication of voiceband data associated with the subscriber line. The gateway must also be capable of interfacing with the SLIC for programmatic control of the SLIC itself. The gateway embodiment of FIG. 4 leverages the existing PCM and SPI interfaces found in present-day SLICs. Thus, for example, the gateway 422 includes a PCM block 462 and an SPI block 464 for interfacing with the PCM interface 440 and the SPI 450 of the SLIC 410.

Full incorporation of the SLIC into the gateway as a larger integrated circuit or integrated circuit package is not feasible due to the thermal load generated by the linefeed driver component of the SLIC. In addition, physical separation of at least the linefeed driver component of the SLIC from the gateway offers the opportunity for an additional layer of electrical isolation of the gateway from the subscriber line. However, the existing SPI and PCM interfaces for SLICs implies that the gateway needs at least 8 pins to support a single SLIC through these interfaces even though the service block ultimately only interfaces with a two wire subscriber line.

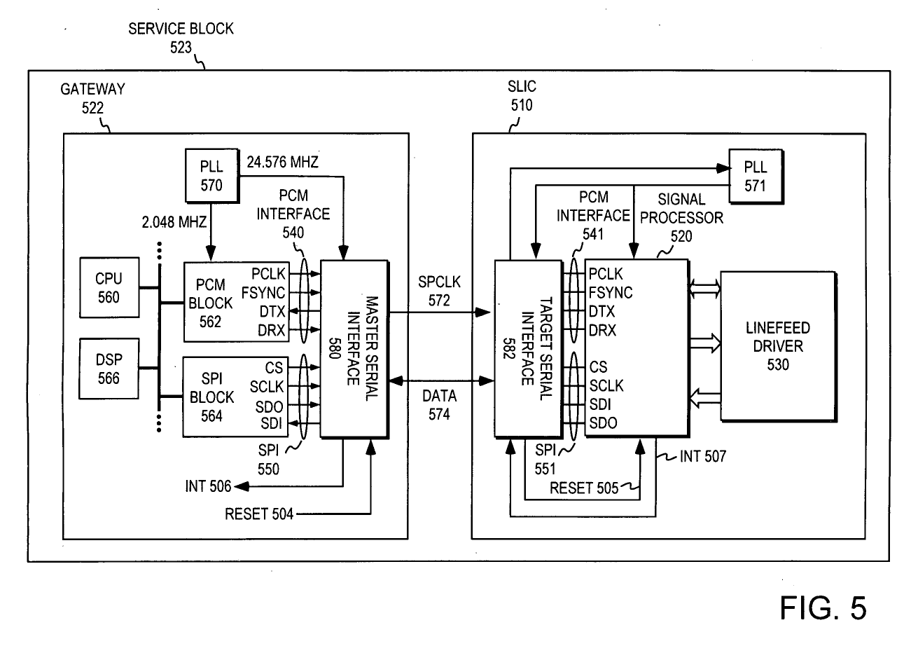

FIG. 5 illustrates one embodiment of service block 523 with an improved interface between the gateway 522 and the SLIC 510 to support better scalability and reduced manufacturing costs for each while maintaining support for existing interfaces internal to these components.

A hardware serializer/deserializer is implemented on both the gateway 522 and the SLIC 510. The PCM data stream and control signals and the SPI data stream and control signals are encoded into a single bi-directional data 574 signal line. In combination with a clock 572 provided by the gateway, the number of integrated circuit pins required to interface with the SLIC is reduced from 8 to 2 pins.

The fixed rate PCM data and the synchronous variable data rate SPI are converted and combined into a single bi-directional data 574 signal line to reduce pin count and circuit board traces associated with the integrated circuit packages of the gateway and the SLIC. A clock signal SPCLK 572 is provided by the gateway to the SLIC for synchronous communications on data 574. The gateway interface is referred to as the “master serial interface” (MSIF 580) and the SLIC interface is referred to as the “target serial interface” (TSIF 582).

The remainder of the gateway 522 is preserved including the CPU 560 and DSP 566. The PCM block 562 and SPI block 564 perform the same functions as before. Rather than connecting directly to a counterpart PCM block on SLIC 510 through a SLIC PCM interface 541 or directly to a counterpart SPI block on SLIC 510 through a SLIC SPI interface 551 (as provided by signal processor 520), these blocks are now coupled to their counterparts through the MSIF 580 and TSIF 582 interfaces. PLL 570 also provides a 24.576 MHz clock to the MSIF 580. This 24.576 MHz clock becomes the SPCLK 572 provided to the TSIF 582. PLL 571 may utilize the SPCLK signal received by TSIF 582 to generate a clock for the signal processor 520. In one embodiment, the MSIF is responsive to a reset 507 issued by the gateway. Similarly, the MSIF is provided with means to issue an interrupt 506 to the gateway.

The PCM interface 540 includes the PCLK, FSYNC, DTX, and DRX signal lines. PCM block 562 asserts an FSYNC signal on one signal line (i.e., FSYNC) to indicate the beginning of a frame for one or more channels of PCM data. The PCM data for each channel comprises a plurality of bits. Upon assertion of the FSYNC signal, the bits for each channel are successively serially transmitted on the DRX line for communications going to the SLIC. Separate signal lines are also used for the upstream data from the SLIC (i.e., DTX) and the downstream data to the SLIC (i.e., DRX). The PCM interface is a synchronous interface. The PCM data is clocked with PCLK.

The SPI 550 includes the SCLK, SDI, SDO, and CS signal lines. CS represents a chip select signal. SDI is a signal line used to communicate serial data to the SLIC (i.e., “serial data in”). SDO is a signal line used to communicate serial data from the SLIC (i.e., “serial data out”). The SPI interface is a likewise a serial data interface. The data is clocked by SCLK. Although the SDI and PCM interfaces are both synchronous, they are not required to be synchronous with respect to each other (i.e., no specific relationship between PCLK and SCLK is required).

The remainder of the SLIC is likewise preserved. Signal processor 520 senses and controls linefeed driver 530 and communicates PCM data and SDI data on the same interfaces (541, 551). In one embodiment, the TSIF can force a reset of the signal processor via reset 505. The TSIF may also be responsive to an interrupt 507 issued by the signal processor.

In order to reduce the pin count, the SDI and PCM data to be communicated between the SLIC and the gateway is integrated and carried on a shared bi-directional signal line, DATA 574. In particular, the PCM data and SDI data are carried by a single bi-directional signal line. A separate signal line is utilized for the clock, SPCLK 572.

The communications between the gateway and SLIC are organized into frames of serial data. The frames are synchronously transmitted in accordance with SPCLK. Each frame has a plurality of bit positions corresponding to timeslots within the frame as demarcated by SPCLK. The SPCLK is a multiple of the PCLK associated with the PCM interface of the MSIF and TSIF.

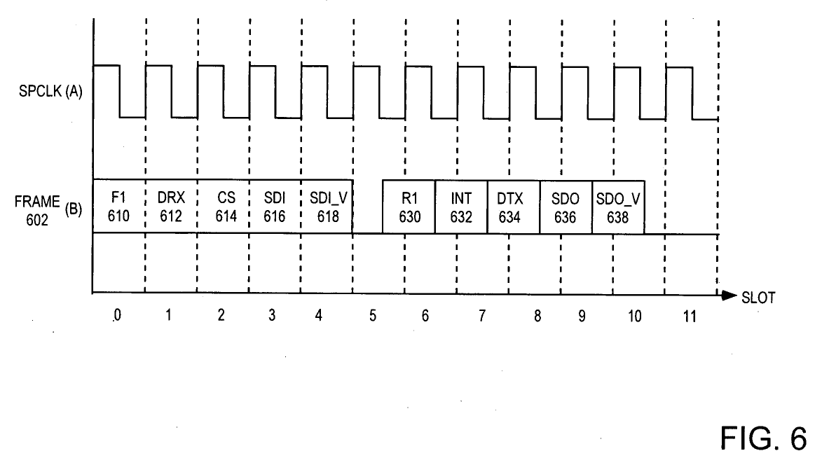

FIG. 6 illustrates one embodiment of a frame 602 utilized for carrying the SDI and PCM signals on a common signal line. Frame 602 is a 12-bit or 12 timeslot frame. Generally the frame is bifurcated such that downstream communications are clustered together and upstream communications are clustered together. Waveform (a) corresponds to the SPCLK signal. Waveform (b) illustrates communication of the frame with respect to the SPCLK signal.

The downstream bits include F1 610, DRX 612, CS 614, SDI 616, and SDI_V 618. DRX 612 is the same as the DRX of the PCM interface 540. In one embodiment, F1 and FSYNC of the PCM interface share the same timeslot. During synchronization to identify the edge of frame 602, for example, the timeslot may be used by F1. Once synchronization has been established, the timeslot may be utilized for the PCM FSYNC signal.

With respect to the SPI portion of the downstream data, CS 614 serves as a chip select indicator. Another component (TSIF 582) will assert the chip select after being signaled by CS 614.

Although the PCM and SPI data streams are synchronous, they are not required to be source synchronous with respect to each other. In addition, they may have clocks (i.e., PCLK and SCLK) of differing frequencies.

In order to support an SPI data stream that is not source synchronous to the PCM data stream, each bit of SDI 616 is qualified by another bit (SDI_V 618) to ascertain the validity of the SDI 616 bit. This approach permits the bi-directional data bus 574 to carry data that may be generated asynchronously relative to the SPCLK 572 signal.

The upstream data includes a “reverse frame” bit (R1 630), interrupt signal (INT 632), transmit signal (DTX 634), and a serial data out (SDO 636). The DTX 634 carries the upstream PCM data. As previously noted, the SPI communications may be asynchronous relative to the PCM communications. Accordingly, an output serial data valid bit (SDO_V 638) is used to qualify the SDO bit. The SDO 636 and SDO_V 638 represent the upstream serial SPI data.

Frame 602 illustrates the serial transmission of data from the perspective of the gateway. The downstream bits are communicated synchronously with the SPCLK. In one embodiment, the SLIC TSIF phase shifts the upstream data bits by 90 degrees to facilitate detection by the gateway MSIF. The F1 610 and R1 630 timeslots are used primarily to establish frame synchronization between the MSIF and TSIF.

Referring to FIG. 5, data bus 574 is a bi-directional, serial data bus. Frames of data are communicated synchronously in accordance with clock signal SPCLK. The data within the frame is not required to be synchronous to SPCLK. Thus the TSIF and MSIF interfaces along with the frame 602 provide for the communication of relatively asynchronous signals bi-directionally on a common bus without altering the ability of the gateway or SLIC to process PCM and SPI communications. The SCLK for the TSIF SPI interface is recovered from the SDI_V bit. PCLK for the PCM interface may be recovered from SPCLK by applying a “divide-by-s” counter to the SPCLK, where s corresponds to the number of timeslots of the frame.

Clock 572 is used as a reference clock for the SLIC's PLL 571. In one embodiment, this reference clock is also provided to the TSIF to permit phase adjustment relative to the frame timeslot for data sent to the MSIF. The F1 bit of frame 602 may be used to verify PLL 571 lock status.

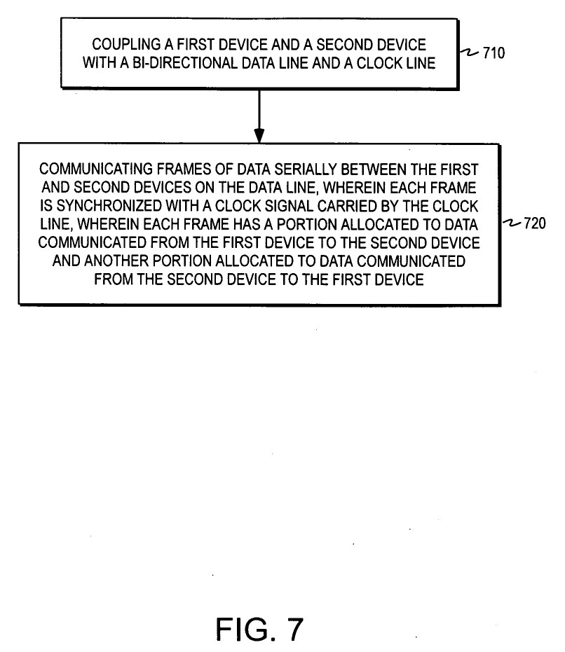

FIG. 7 illustrates a method of communicating between these devices. A first device and a second device are coupled 710 with a bi-directional data line and a clock line. Frames of data are communicated 720 between the first and second devices on the data line. Each frame is synchronized with a clock signal carried by the clock line. Each frame has a portion allocated to data communicated from the first device to the second device and another portion allocated to data communicated from the second device to the first device.

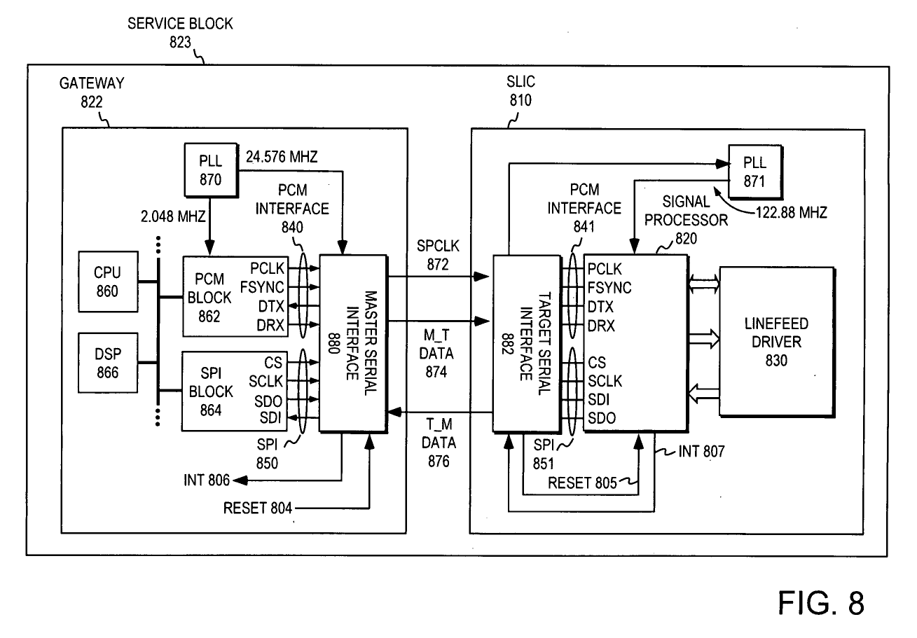

FIG. 8 illustrates one embodiment of service block 823 with a three-wire interface for coupling a SLIC 810 and a gateway 822 to transport PCM and SPI communications. In particular, the three-wire interface includes a clock line (SPCLK 872), a first unidirectional data line (M_T DATA 874, i.e., “master-to-target”) communicating data from the gateway to the SLIC, and a second unidirectional data line (T_M DATA 876, i.e., “target-to-master”) carrying data from the SLIC to the gateway. In one embodiment, SPCLK is the clock provided by PLL 870 (i.e., 24.576 MHz).

The TSIF 882 receives the SPCLK signal and provides the signal to a PLL 871. PLL 871 utilizes the SPCLK signal to generate a 122.88 MHz clock signal for the operation of the SLIC signal processor 820.

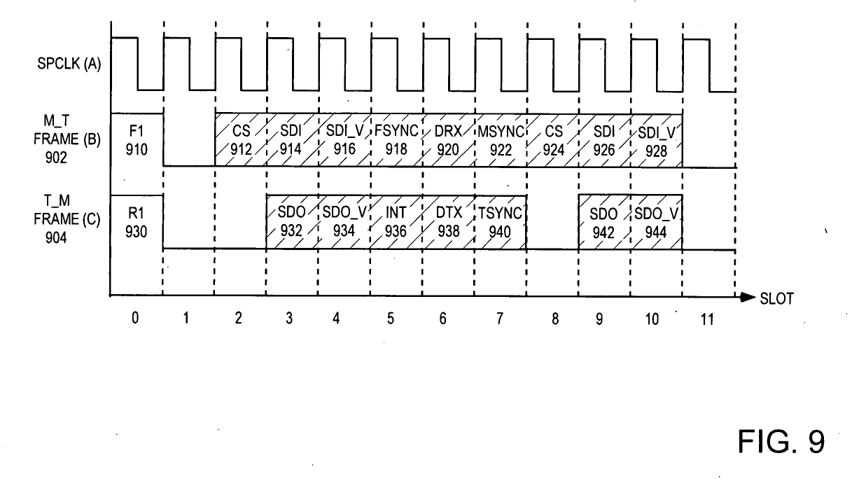

Each unidirectional data line (874, 876) is associated with a particular frame for communication. FIG. 9 illustrates one embodiment of master-to-target frame (M_T FRAME 902) illustrated in waveform (b) as well as a target-to-master frame (T_M FRAME 904) illustrated in waveform (c). Each frame is a 12-bit or 12 timeslot frame. The SPCLK is provided in waveform (a).

M_T FRAME 902 includes F1 910, CS 912, SDI 914, SDI_V 916, FSYNC 918, DRX 920, MSYNC 922, CS 924, SDI 926, and SDI_V 928. Thus this frame supports up to two SDI, SDI_V, and CS bits per transmission (e.g., SDI 914 and SDI 926 represent distinct SDI bits rather than duplicates of the same bit). “F1” is the “forward frame” (i.e., downstream) frame synchronization bit.

T_M FRAME 904 includes a synchronization bit (R1 930), SDO 932, SDO_V 934, INT 936, DTX 938, TSYNC 940, SDO 942, and SDO_V 944. Thus the frame supports two SDO, SDO_V bits per transmission. “R1” is the “reverse frame” (i.e., upstream) frame synchronization bit. The INT slot enables the TSIF to pass an interrupt request to the gateway.

PLL 871 of the SLIC locks to SPCLK to enable the SLIC to send T_M FRAMEs in synchronization with the received SPCLK. PLL 871 generates the clock for the signal processor 820 from SPCLK. The SCLK for the TSIF SPI interface is recovered from the SDI_V bits. Given a 24.576 MHZ SPCLK, 12 timeslots frames, and 2 SPI data bits per transmission, this frame architecture supports an SPI interface SCLK rate of 4.096 MHZ. This three-wire interface thus provides support for a SPI data rate that is faster than the two-wire bidirectional data line embodiment.

MSYNC 922 indicates to the TSIF 882 whether the MSIF 880 has acquired (or lost) synchronization. Similarly TSYNC 940 indicates to the gateway 822 whether the TSIF has acquired (or lost) synchronization. The remaining components of the gateway and SLIC (e.g., PCM interfaces 840, 841; PCM block 862; SPI 850, 851; SPI block 864; CPU 860; DSP 866; INT 806, 807; RESET 804, 805; and linefeed driver 830) perform in the same fashion as the corresponding elements described with respect to FIG. 5.

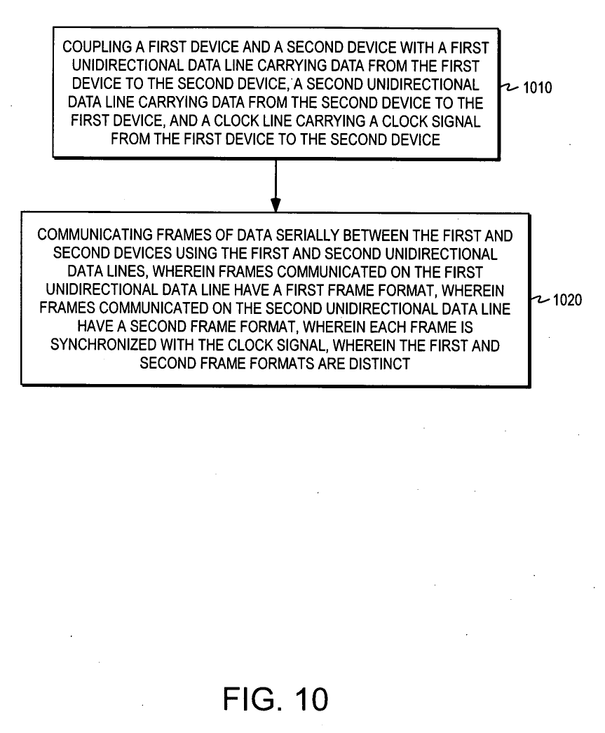

FIG. 10 illustrates one embodiment of a method of communicating serially between a first and a second device (such as a gateway and a SLIC) using the three-wire interface.

A first device and a second device are coupled 1010 with a first unidirectional data line, a second unidirectional data line, and a clock line. The first unidirectional data line carries data from the first device to the second device. The second unidirectional data line carries data from the second device to the first device. The clock line carries a clock signal from the first device to the second device.

Frames of data are serially communicated 1020 between the first and second devices using the first and second unidirectional data lines. Frames communicated on the first unidirectional data line have a first format. Frames communicated on the second unidirectional data line have a second format. Each frame is synchronized with the clock signal. The first and second frame formats are distinct. In one embodiment, the first format combines PCM and SDI signals for communication from the first device to the second device. Similarly, the second format combines PCM and SDI signals for communication from the second device to the first device.

As noted, the additional wire enabled a faster SPI SCLK rate. However, the faster SCLK rate may also be supported by a two-wire interface with the addition of clock recovery circuitry. The clock recovery circuitry allows for dispensing with the dedicated clock line 872 of FIG. 8 such that SPCLK (or a proxy) can be recovered by the TSIF from the M_T DATA line.

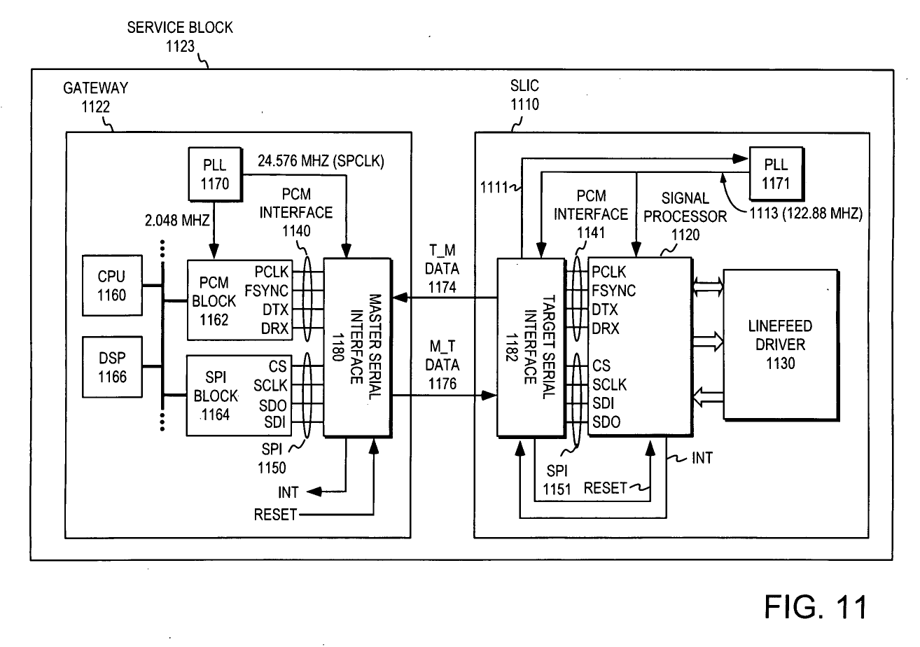

FIG. 11 illustrates an alternative embodiment of a service block 1123 with a two-wire interface for coupling a SLIC 1110 and a gateway 1122 to transport PCM and SPI communications. In particular, the two-wire interface includes a first unidirectional data line (M_T DATA 1174, i.e., “master-to-target”) communicating data from the gateway to the SLIC, and a second unidirectional data line (T_M DATA 1176, i.e., “target-to-master”) carrying data from the SLIC to the gateway.

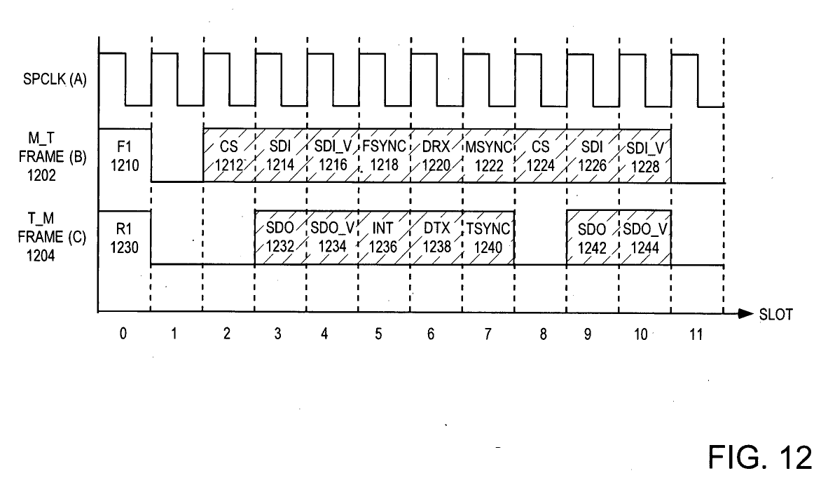

Each unidirectional data line (1174, 1176) is associated with a particular frame for communication. FIG. 12 illustrates one embodiment of a master-to-target frame (M_T FRAME 1202) in waveform (b) as well as a target-to-master frame (T_M FRAME 1204) in waveform (c). Each frame is a 12 timeslot frame. SPCLK is provided in waveform (a), however, the SPCLK is not explicitly communicated between the MSIF 1180 and TSIF 1182.

M_T FRAME 1202 includes F1 1210, CS 1212, SDI 1214, SDI_V 1216, FSYNC 1218, DRX 1220, MSYNC 1222, CS 1224, SDI 1226, and SDI_V 1228. Thus this frame supports two SDI, SDI_V, and CS bits per transmission (e.g., SDI 1114 and SDI 1126 represent distinct SDI bits rather than duplicates of the same bit). The SCLK for the TSIF SPI interface is recovered from the SDI_V bits (1216, 1228).

T_M FRAME 1204 includes a synchronization bit (R1 1230), SDO 1232, SDO_V 1234, INT 1236, DTX 1238, TSYNC 1240, SDO 1242, and SDO_V 1244. Thus the frame supports two SDO, SDO_V bits per transmission.

MSYNC 1222 indicates to the TSIF 1182 whether the MSIF 1180 has acquired (or lost) synchronization. Similarly TSYNC 1240 indicates to the gateway 1122 whether the TSIF has acquired (or lost) synchronization.

With the possible exception of PLL 1171, other gateway and SLIC components such as the PCM interfaces 1140, 1141; PCM block 1162; SPI 1150, 1151; SPI block 1164; CPU 1160; DSP 1166 and linefeed driver 1130 perform in the same fashion as the corresponding elements described with respect to FIG. 5.

Although an SPCLK signal is illustrated for timing purposes, the SPCLK is internal to the gateway 1122 and is not explicitly communicated from the gateway to the SLIC 1110. The SPCLK or a proxy is recovered or generated from the M_T FRAME. In particular, the F1 bit is used to generate a clock synchronous to the gateway's SPCLK.

Referring to FIG. 11, the TSIF 1182 provides the F1 detect signal 1111 to PLL 1171. This detect signal is used to determine PLL lock when generating a clock 1113 synchronous to the gateway's SPCLK. In one embodiment, PLL 1171 generates a clock that is a multiple of the SPCLK.

SLIC 1110, for example, may require a clock of a greater frequency than SPCLK. This generated clock is provided to the TSIF 1172 and the SLIC 1110. The higher frequency also allows for finer granularity with respect to sampling as described in greater detail below.

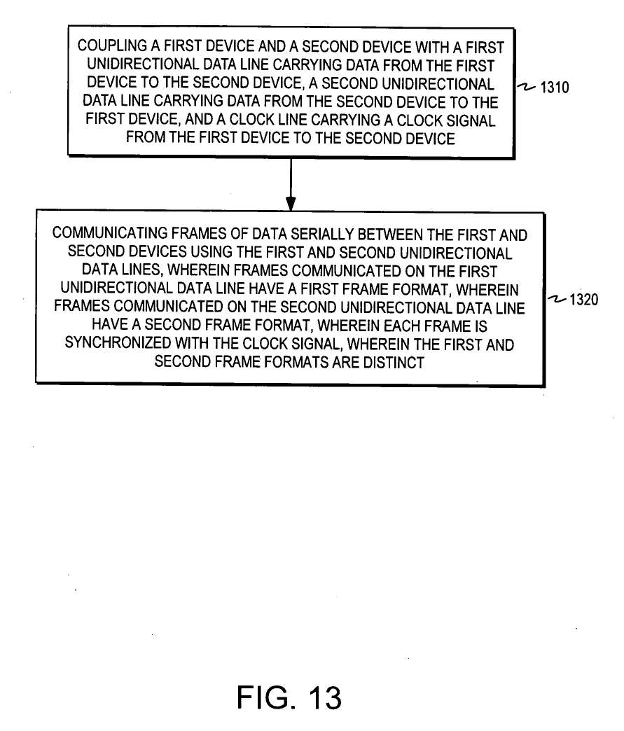

FIG. 13 illustrates one embodiment of a method of communicating serially between a first and a second device (such as a gateway and a SLIC) using this two-wire interface.

A first device and a second device are coupled 1310 with a first unidirectional data line and a second unidirectional data line. The first unidirectional data line carries data from the first device to the second device in accordance with a clock of the first device. The second unidirectional data line carries data from the second device to the first device in accordance with a clock generated by the second device from the data carried by the first unidirectional line.

Frames of data are serially communicated 1320 between the first and second devices using the first and second unidirectional data lines. Frames communicated on the first unidirectional data line have a first format. Frames communicated on the second unidirectional data line have a second format. Each frame is synchronized with the clock signal.

The gateway and SLIC must be able to synchronize receipt of frames from each other. Upon power up or reset, for example, each device must be able to locate the beginning of a frame from the other device in order to identify the beginning of each frame in the data stream.

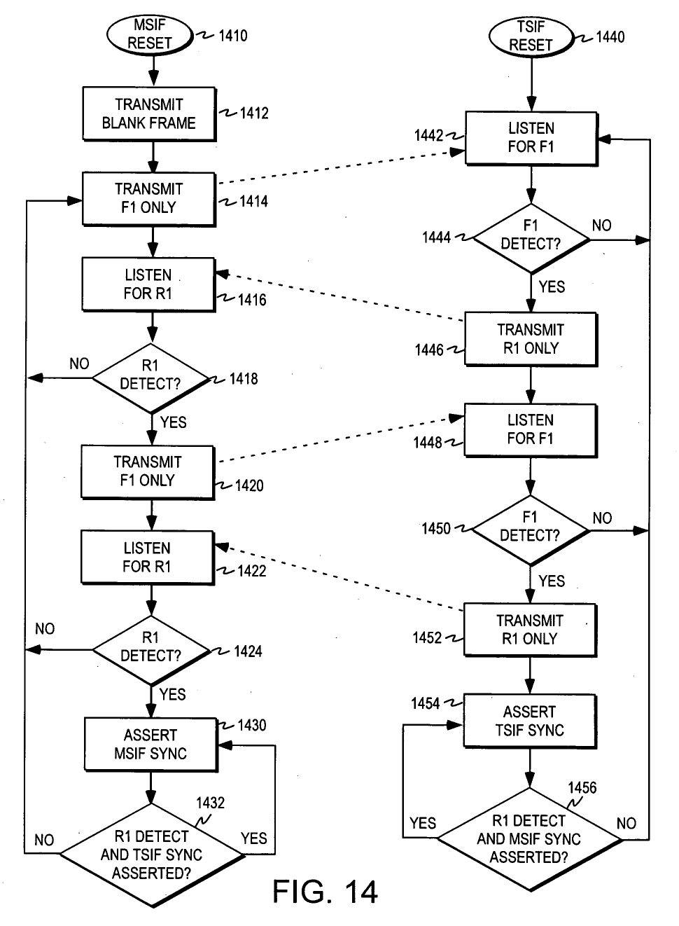

FIG. 14 illustrates one embodiment of a frame synchronization protocol for the MSIF and TSIF. These components are subject to the possibility of having to take steps to synchronize with each other for various reasons. For example, upon a power-up event, there is no initial synchronization between the MSIF and TSIF interfaces. One or the other device may be reset such that an existing synchronization is lost. One device may be taken temporarily out of service, for example, while a firmware update is applied.

The synchronization protocol for the MSIF is illustrated in 1410-1432. The synchronization protocol for the TSIF is illustrated in 1440-1456. These protocols co-operate with each other. There is not a “session” or “link” established between the MSIF and TSIF. Once synchronization is achieved for a given device, the other device is presumed to be properly functioning until such a time as the other device specifically indicates that it has lost synchronization or the given device has determined a loss of synchronization.

The MSIF synchronization begins from a reset state at 1410. Once a reset is de-asserted, the MSIF suppresses transmission of any “ones”. Thus at 1412, the MSIF transmits only logical “zeroes” in every slot of the MSIF frame on the M_T data line. The MSIF then proceeds to transmit a frame consisting of a first F1 bit at 1414 (only the F1 slot is permitted to have a non-zero value). This is the beginning of the portion of the protocol that requires transmission of two synchronization frames and confirmation of receipt by the TSIF before synchronization is deemed to have occurred.

After transmitting a frame with the first F1 bit, the MSIF listens for a first R1 bit at 1416.) The MSIF is attempting to detect the presence of a return frame from the TSIF on the T_M data line. If synchronization is non-existent at this point, then the TSIF will be transmitting frames having a non-zero value only for the R1 slot position. If the first R1 bit is not detected, the MSIF returns to step 1414.

If the first R1 bit is detected as determined by step 1418, the MSIF proceeds to transmit another frame consisting of zeroes for every slot except the F1 slot. Thus the MSIF is transmits a second F1 bit at 1420. If the MSIF does not receive a frame containing this first R1 bit as determined by step 1418, then the MSIF synchronization protocol returns to step 1414 to restart the synchronization process again.

After transmitting the second F1 bit at 1420, the MSIF listens for a second R1 bit at 1422. If step 1424 determines that there was no second R1 bit received, then the MSIF synchronization protocol returns to step 1414. If the second R1 bit is received, however, the MSIF asserts its MSIF SYNC in 1430. Each M_T frame will have the value for MSIF SYNC asserted until such a time as synchronization is lost again as indicated by step 1432. Synchronization can be lost if either TSIF SYNC is not asserted or if the MSIF is unable to detect an R1 (i.e., a return frame sync). If synchronization is lost, then processing returns to 1414 rather than 1410 or 1412 in order to ameliorate the impact on PLLs such as PLL 1171 as an attempt is made to regain synchronization.

A complementary process occurs with the TSIF. The TSIF synchronization begins from a reset state at 1440. Once a reset is de-asserted, the TSIF listens for a first F1 bit from the MSIF at 1442. The TSIF suppresses transmission of any “ones” at this time. Thus at 1442, the TSIF transmits only logical “zeroes” in every slot of the TSIF frame on the T_M data line.

If no F1 is received as determined by step 1444, the TSIF continues to listen for the first F1 from the MSIF at 1442. The receipt of the F1 bit of the M_T frame is also used for clock recovery to derive SPCLK as set forth in further detail in a subsequent figure. Once the first F1 bit is received, the TSIF sends the first T_M frame having only the R1 timeslot asserted at 1446.

After sending such a frame, the TSIF listens for a second F1 bit at 1448. If step 1450 determines that the second F1 bit was not received, then the synchronization process starts again from step 1442. Otherwise, the TSIF transmits a second frame having only the R1 slot asserted at step 1452 and then asserts TSIF_SYNC at step 1454. The TSIF_SYNC is asserted by asserting the TSIF_SYNC value in every T_M frame until such a time as the TSIF determines that synchronization is lost as determined by step 1456. Synchronization can be lost if either the received MSIF SYNC is not asserted or if the TSIF is unable to detect an F1 (i.e., a frame sync). If synchronization is lost, processing continues with step 1442 to regain synchronization.

The dotted arrows between the two synchronization protocols illustrate how the protocols co-operate or complement each other. However, steps 1410-1432 are performed exclusively by the MSIF while steps 1440-1456 are performed exclusively by the TSIF.

The remaining slot positions in each of the M_T frame and T_M frame may now be utilized for communicating the PCM- and SPI-related data as set forth in the frame descriptions.

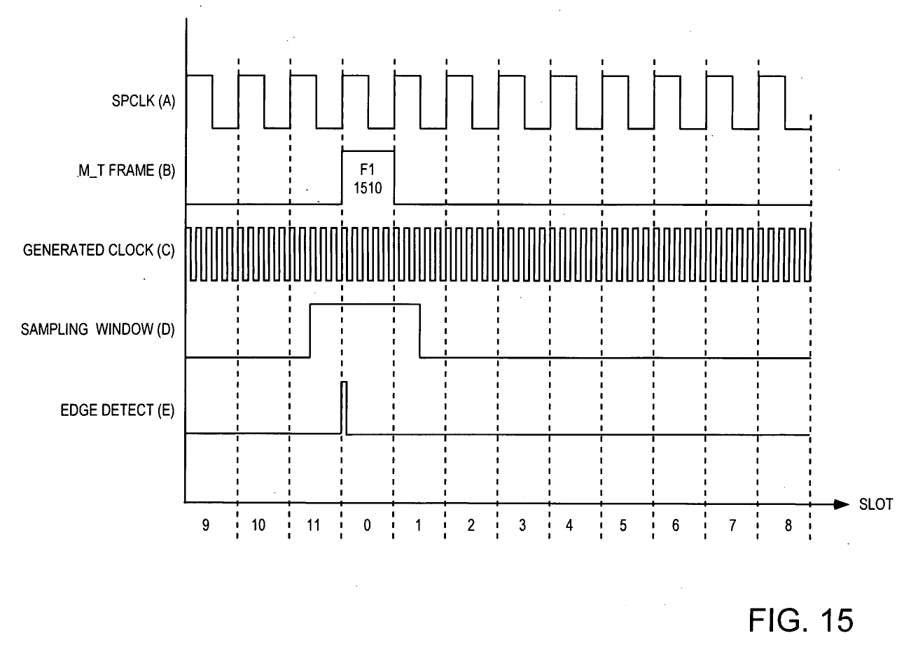

FIG. 15 illustrates one embodiment of waveforms associated with detecting an edge of a frame for recovering/generating a clock signal. Waveform (a) illustrates the MSIF SPCLK (internal to the gateway) provided only for comparison. Waveform (b) illustrates an M_T frame during synchronization. Only the F1 1510 timeslot has an asserted bit.

Once the F1 is detected, it is fed to PLL 1171 as a reference. The PLL starts to lock to the F1 pulse. Once the internal PLL lock is achieved, the SLIC may switch to utilizing the clock signal generated by PLL 1171. The generated clock is illustrated in waveform (c). The generated clock has a frequency that is a multiple of the SPCLK and therefore an even greater multiple of the frequency with which the frames are communicated.

Referring to FIG. 11, the TSIF utilizes a clock from PLL 1171 to sample the M_T data line. In the illustrated embodiment PLL is providing a 122.88 MHz clock signal, i.e., a clock five time faster than the MSIF SPCLK.

At the time the TSIF is listening for the first F1 bit, the TSIF sampling window is “wide open” (e.g., throughout the length of each periodic frame) to locate the F1 bit. Once the F1 bit has been detected, the detection window for the edge of the F1 slot is effectively narrowed as indicated by waveform (d). This detection window helps ensure that PLL 1171 will not attempt to lock to data carried by the other timeslots of the M_T frame once the M_T frame is populated with data. Waveform (e) is provided merely to illustrate one embodiment of an edge detect signal to be provided to PLL 1171 as the reference once synchronized.

Due to the higher frequency clock provided by PLL 1171, each M_T frame consumes 60 cycles of the 122.88 MHz clock. The M_T frame format provides a “guard space” around the F1 bit due to slots 1 and 11. This provides considerable leeway to ensure synchronization to F1 as opposed to another slot position in the event of jitter. The edge detection window fixes the output of TSIF to PLL 1171 until approximately the time at which the F1 edge is expected. This may be achieved, for example, by using a counter and combinatorial logic that provides fixed output to PLL 1171 until the TSIF counter driven by the PLL 1171 reaches a value in a range near 60 such as 55-65. The difference between the actual value and the expected value of the counter may be used to adjust when the sampling is initiated, if necessary.

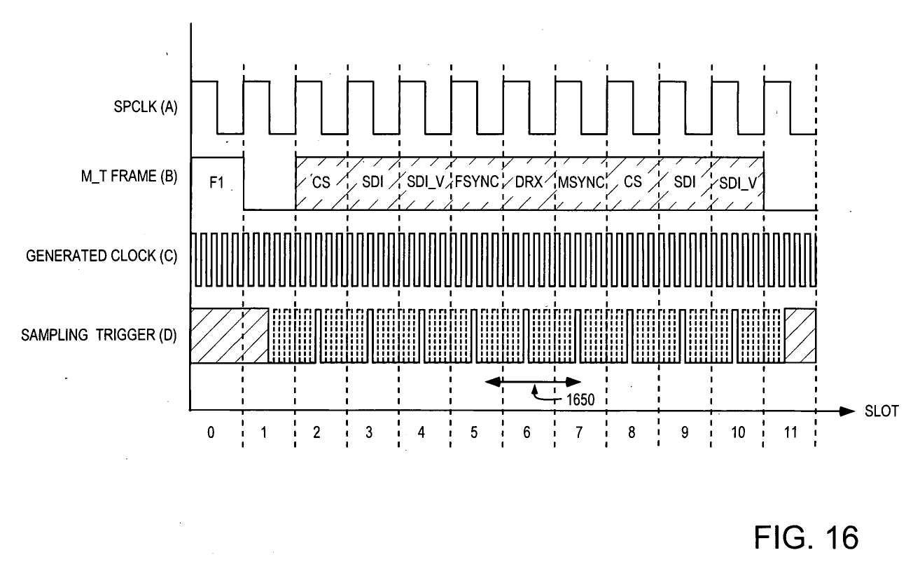

FIG. 16 illustrates one embodiment of the waveforms utilized for sampling the M_T frames. Waveform (a) corresponds to the SPCLK signal internal to the gateway and is provided for comparison. Waveform (b) illustrates an M_T frame carried by the M_T data line. Waveform (c) illustrates the clock generated by PLL 1171. Waveform (d) illustrates the granularity with which the sampling of the M_T data line may be varied.

The trigger for sampling the M_T data line may use a divide-by-n counter where n reflects the ratio of the frequency of the generated clock to that of SPCLK. Although the sampling is triggered every n cycles of the generated clock, the position of the sampling trigger may be varied relative to the beginning of an M_T frame timeslot by an integer number of generated clock cycles. This is accomplished, for example, by pre-loading the divide-by-n counter with an appropriate offset value when the F1 edge is detected. Varying this offset value changes when the M_T frame timeslots are sampled as indicated by 1650.

In the illustrated embodiment, the pulse serving as the sampling trigger occurs approximately in the middle of each timeslot to be sampled. Changing the value of the offset will select a different generated clock pulse as the sampling trigger. Thus the faster generated clock enables a finer granularity of control with respect to when the timeslots are sampled.

Thus for the two-wire case with clock recovery, the method of communication includes communicating frames of data having a first timeslot allocation of s timeslots serially from a first device to a second device using a first unidirectional data line at a frequency f₁. A clock signal having a frequency f₂ is generated within the second device, wherein

$$\frac{{f}_{2}}{{f}_{1}} \approx n \cdot s ,$$

wherein n>1. The “≈” symbol means “approximately equal to”. Jitter, for example, may hinder equality. In the illustrated embodiments s=12, n=5.

The first unidirectional data line is sampled every n clock cycles of the clock signal for a plurality of the timeslots. The generated clock granularity enables sampling the first unidirectional data line at a pre-determined one of n clock cycles for a first of the plurality of timeslots. Frames of data having a second timeslot allocation of s timeslots are communicated on the second unidirectional data line at a frequency f₁ from the second device to the first device.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method of communicating comprising:
a) coupling a first device and a second device with a bi-directional data line and a clock line; and
b) communicating frames of data serially between the first and second devices on the data line, wherein each frame is synchronized with a clock signal carried by the clock line, wherein each frame has a portion allocated to data communicated from the first device to the second device and another portion allocated to data communicated from the second device to the first device.

2. The method of claim 1 wherein the second device is a subscriber line interface circuit.

3. The method of claim 1 wherein the first device is a gateway for an optical network.

4. The method of claim 1 wherein the frame carries an FSYNC, DTX, and DRX value from a PCM interface of one of the first and second devices, wherein an SPCLK carried by the clock line is a multiple of a PCLK associated with each PCM interface.

5. The method of claim 1 wherein the frame carries a CS, SDI, and SDO value from an SPI interface of one of the first and second devices.

6. The method of claim 1 wherein the frame carries an FSYNC, DTX, and DRX value from a PCM interface of one of the first and second devices, wherein an SPCLK carried by the clock line is a multiple of a PCLK associated with each PCM interface, wherein the frame carries a CS, SDI, and SDO of an SPI interface of one of the first and second devices.

7. The method of claim 6 wherein the frame carries an SDI_V bit and an SDO_V bit to qualify the validity of the SDI and SDO bits for each frame.

8. The method of claim 1 wherein the first device is an optical network gateway, wherein the second device is a SLIC, wherein the frame carries an FSYNC, DTX, and DRX value from a PCM interface of one of the first and second devices, wherein an SPCLK carried by the clock line is a multiple of a PCLK associated with each PCM interface, wherein the frame carries a CS, SDI, and SDO of an SPI interface of one of the first and second devices.

9. A communication apparatus, comprising:
a first device;
a second device coupled to the first device with a bi-directional data line and a clock line;
wherein frames of data are serially communicated between the first and second devices on the data line, wherein each frame is synchronized with a clock signal carried by the clock line, wherein each frame has a portion allocated to data communicated from the first device to the second device and another portion allocated to data communicated from the second device to the first device.

10. The apparatus of claim 9 wherein the second device is a subscriber line interface circuit.

11. The apparatus of claim 9 wherein the first device is an optical network gateway.

12. The apparatus of claim 9 wherein the frame carries an FSYNC, DTX, and DRX value from a PCM interface of one of the first and second devices, wherein an SPCLK carried by the clock line is a multiple of a PCLK associated with each PCM interface.

13. The apparatus of claim 9 wherein the frame carries a CS, SDI, and SDO value from an SPI interface of one of the first and second devices.

14. The apparatus of claim 9 wherein the frame carries an FSYNC, DTX, and DRX value from a PCM interface of one of the first and second devices, wherein an SPCLK carried by the clock line is a multiple of a PCLK associated with each PCM interface, wherein the frame carries a CS, SDI, and SDO of an SPI interface of one of the first and second devices.

15. The apparatus of claim 14 wherein the frame carries an SDI_V bit and an SDO_V bit to qualify the validity of the SDI and SDO bits for each frame.

16. The apparatus of claim 9 wherein the first device is an optical network gateway, wherein the second device is a SLIC, wherein the frame carries an FSYNC, DTX, and DRX value from a PCM interface of one of the first and second devices, wherein an SPCLK carried by the clock line is a multiple of a PCLK associated with each PCM interface, wherein the frame carries a CS, SDI, and SDO of an SPI interface of one of the first and second devices.
